(19) United States
(12) Patent Application Publication
(10) Pub. No.: US 2010/0111568 A1
(43) Pub. Date: May 6, 2010

(54) CHARGING DEVICE AND IMAGE FORMING APPARATUS

(75) Inventors: Shunichi TAKAYA, Toyokawa-shi (JP); Shinichi Yoshimoto, Toyohashi-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/607,459

(22) Filed: Oct. 28, 2009

(30) Foreign Application Priority Data
Oct. 30, 2008 (JP) 2008-279521

(51) Int. Cl. G03G 15/02

(52) U.S. Cl. 399/170

(57) ABSTRACT

Disclosed is a charging device for charging the surface of a rotating image carrier. The charging device includes a shielding case having an opening at a location facing toward the image carrier, a corona electrode hung within the shielding case to extend in a direction perpendicular to the rotating direction of the image carrier, a control electrode disposed at a location of the opening. The shielding case as a pair of side plates opposed to each other in the rotating direction of the image carrier. At least one of the side plates has a portion that outwardly bulges at a location in the vicinity of the opening.

This application is based on an application No. 2008-279521 filed in Japan, the contents of which are hereby incorporated by reference.

### BACKGROUND OF THE INVENTION

(1) Field of the Invention

The present invention relates to a charging device used in an electrographic image forming apparatus, and especially to a technique of suppressing production of ozone resulting from discharge in the charging device. The aim of suppressing the production of ozone is to prevent deterioration of the surrounding components caused by ozone and also to prevent an image defect resulting from degradation of the photoreceptor sensitivity caused by deteriorated substances.

(2) Description of the Related Art

Generally, an electrographic image forming apparatus is provided with a scorotron charging device. Regarding scorotron charging devices, there have been demands for further improvement in efficiency and reduction of ozone production. In order to meet the demand, it has become the mainstream to employ a discharge electrode having a serrated edge, rather than a conventional wire-type discharge electrode.

A discharge electrode with a serrated edge produces a discharge in limited directions as compared with that produced by a wire-type discharge electrode. By virtue of this property, the discharge electrode with a serrated edge is capable of producing a high energy discharge comparatively efficiently in view of the applied voltage and the supplied current. In addition, since the discharge is produced from the tips of the serrated edge, the amount of ozone produced is relatively small.

Yet, even with such a discharge electrode having a serrated edge, the following is still unavoidable. That is, ozone produced at the time of discharge eventually causes, by ozone oxidation and other actions, corrosion of the shielding member provided to encompass the discharge electrode. As a result, deteriorated substances such as rust are formed. The deteriorated substances tend to act as a source of a gas that affects the photoreceptor sensitivity and release the gas at the timing irrelevant to image forming process. As a result, the photoreceptor sensitivity is degraded. The degraded photoreceptor sensitivity in turn causes an undesirable phenomenon called image deletion in which an image is formed with voids appearing white.

In order to address the above, JP patent application publication No. 2007-316197 discloses a technique for suppressing the deterioration of a shielding member.

According to the publication, the charging device is provided with a member for suppressing corrosion and a cleaning mechanism for the corrosion suppressing member. The corrosion suppressing member is made of a material that is more prone to oxidation corrosion than materials of both the stabilizing case and of the control electrode. The oxidation corrosion caused by, for example, ozone produced as a result of discharge by discharge members advances more on the corrosion suppressing member than on the stabilizing case and the control electrode. The corroded corrosion suppressing member can be cleaned by the cleaning mechanism, so that it is maintained that the corrosion suppressing member is more apt to corrosion than the stabilizing case and the control electrode. As a consequence, the corrosion of the stabilizing case and the control electrode is suppressed.

Unfortunately however, the structure disclosed by the publication mentioned above is not desirable for the following reason. That is, the presence of the corrosion suppressing member made of metal inevitably changes the electric field distribution within the charging device and reduces the effective discharge current supplied to the photoreceptor. Thus, the application voltage needs to be increased to increase the amount of discharge current, which requires the provision of a power supply circuit capable of producing higher power output.

In addition, the increase in the amount of discharge current results in that a larger amount of ozone is produced to increase the ozone concentration. In addition, the provision of the corrosion suppressing member and the cleaning mechanism is not desirable also because it increases the complexity of the structure, size, and cost of the overall device.

### SUMMARY OF THE INVENTION

The present invention aims to provide an image forming apparatus and a charging device used in the image forming apparatus that are capable of suppressing corrosion of the shielding member, without the need to increase the structural complexity, size, and cost of the device and apparatus. The image forming apparatus and the charging device according to the present invention are therefore capable of preventing occurrence of image deletion and capable of forming images with good quality over a long time.

In order to achieve the above aim, one aspect of the present invention provides a charging device for charging a surface of a rotating image carrier. The charging device includes: a shielding case having an opening at a location facing toward the image carrier; a corona electrode hung within the shielding case to longitudinally extend in a direction perpendicular to a direction of the rotation; and a control electrode disposed at a location of the opening of the shielding case. A pair of side plates of the shielding case are opposed to each other in the direction of the rotation, and at least one of the side plates has a portion that outwardly bulges at a location in a vicinity of the opening.

According to the structure above, with the shielding case having an opening of an adequate size and with a control electrode of an adequate size, the charging device is still capable of suppressing undesirable discharge affecting the shielding case.

For example, as compared with a conventional shielding case, the shielding case of the above structure is so configured that the electric field strength in the vicinity of the control electrode is kept lower. As a result, the amount of current flowing through the shielding case is reduced, which in turn reduces the amount of ozone produced in the vicinity of the control electrode. This achieves to decrease the corrosion rate of the shielding case and especially of the portion of the shielding case closer to the image carrier. The lower corrosion rate leads to reduction of the adverse influence of gas, which is one factor causing image deletion.

As described above, the present invention achieves to suppress corrosion of the shielding case and thus suppress image deletion, without the need to complicate the device structure and increase the device size and cost. As a result, it is ensured that the charging device according to the present invention is capable of preventing occurrence of image deletion and capable of forming images with good quality over a long time

In order to achieve the above aim, another aspect of the present invention provides an image forming apparatus including: an image carrier that is a rotating body; and a charger operable to charge a surface of the image carrier. The charging device includes: a shielding case having an opening at a location facing toward the image carrier; a corona electrode hung within the shielding case to longitudinally extend in a direction perpendicular to a direction of the rotation; and a control electrode disposed at a location of the opening of the shielding case. A pair of side plates of the shielding case are opposed to each other in the direction of the rotation, and at least one of the side plates has a portion that outwardly bulges at a location in a vicinity of the opening.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a schematic sectional view of an electrographic image forming apparatus consistent with Embodiment 1;

FIG. 2 is a view showing a charging device consistent with Embodiment 1 in detail;

FIG. 3 is a view showing the major part of the charging device shown in FIG. 2, in a cross section taken along a plane perpendicular to the rotation axis x of an image carrier, and also showing a schematic representation of the electrical connection;

FIG. 4 is a view showing the cross section of the charging device shown in FIG. 3, with the distribution of electric field strengths calculated by running simulations;

FIG. 5 is a view showing a cross section of a charging device of a comparative example, with the distribution of electric field strengths calculated by running simulations;

FIG. 6 is a view showing a table of results of experiment to check for occurrence of image deletion in relation to different length of discharge time;

FIG. 7 is a graph showing the distribution of electric field strengths in the vicinity of the image carrier surface;

FIG. 8 is a view showing the major part of a charging device consistent with Embodiment 2, in a cross section taken along a plane perpendicular to the rotation axis x of an image carrier, and also showing a schematic representation of the electrical connection;

FIG. 9 is a view showing the cross section of the charging device shown in FIG. 8, with the distribution of electric field strengths calculated by running simulations;

FIG. 10 is a view showing a table of results of experiment to check for occurrence of image deletion in relation to different length of discharge time;

FIG. 11 is a view showing a cross section of a charging device according to Modification 1, with the distribution of electric field strengths calculated by running simulations; and

FIG. 12 is a view showing a cross section of a charging device according to Modification 2, with the distribution of electric field strengths calculated by running simulations.

### DESCRIPTION OF THE PREFERRED EMBODIMENT

### Embodiment 1

### <Structure>

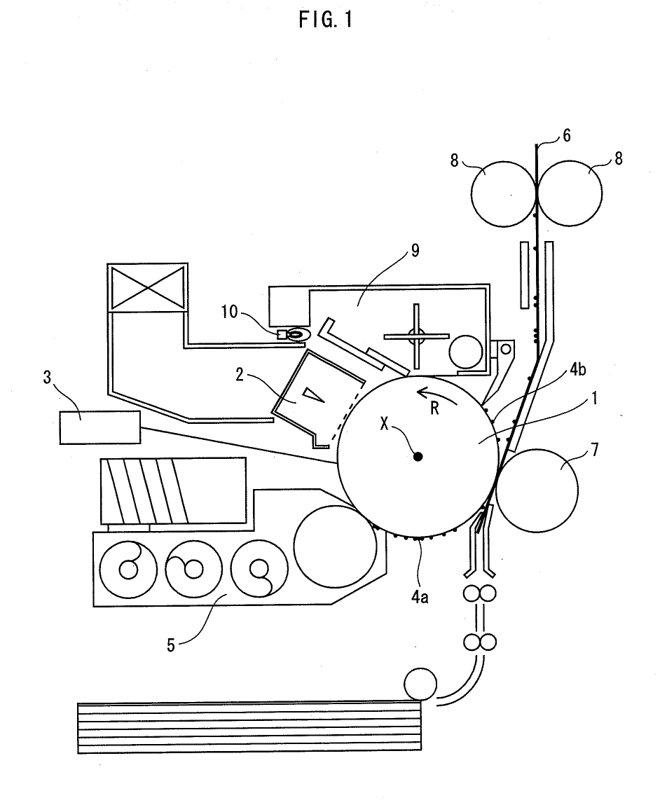

FIG. 1 is a schematic sectional view of an electrographic image forming apparatus consistent with Embodiment 1.

As shown in FIG. 1, the image forming apparatus consistent with Embodiment 1 includes: an image carrier 1, which is an OPC photoreceptor; a charging device 2 for uniformly charging the surface of the image carrier 1 at a predetermined potential; an exposure device 3 for forming an electrostatic latent image by directing laser light to the image carrier 1 having been charged at the predetermined potential; a developer device 5 for developing the latent image by attaching toner particles 4a mainly by the action of electrostatic force; a transfer device 7 for transferring the toner particles 4a from the image carrier 1 to a recording sheet 6, such as a sheet of copier paper, by electrostatic force or pressure; a fusing device 8 for fusing the transferred toner particles 4a on the recording sheet 6, by applying heat and pressure; a clearing device 9 for cleaning the image carrier 1 by electrically or mechanically removing residual toner particles 4b that remain on the image carrier 1 without being transferred to the recording sheet 6; and an antistatic device 10 for equalizing variations in the potential across the image carrier 1 after the cleaning, by exposure to light or with a charged brush, for example.

It should be noted that the charging device 2 has functions performed at an initial phase of the image forming. In order to stably produce high-quality images, it is therefore important that the charging device 2 is ensured to charge the surface of the image carrier 1 at a uniform and stable potential.

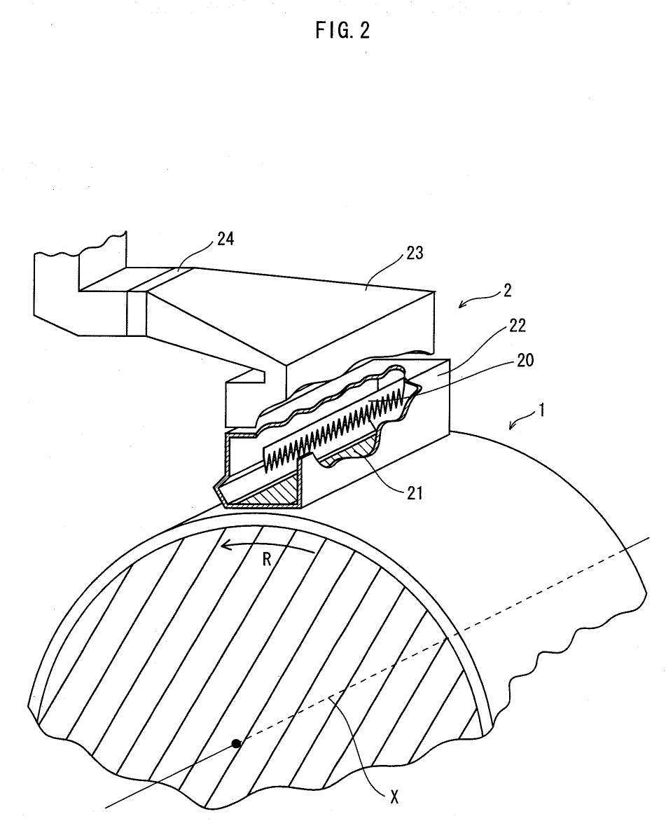

FIG. 2 shows the charging device 2 consistent with Embodiment 1 in detail.

As shown in FIG. 2, the charging device 2 consistent with Embodiment 1 includes a discharge electrode 20, a control electrode 21, a shielding case 22, an air duct 23, and a fun 24.

The discharge electrode 20 is, for example, a corona electrode made of stainless steel to have a serrated edge. The discharge electrode 20 is provided inside the shielding case 22 so as to hang across the shielding case 22 in a direction perpendicular to a rotating direction R of the image carrier 1. The tips of the serrated edge are each located a predetermined discharge distance away from the image carrier 1 and act as a discharging point. When a voltage Vc (−5000V in this example) is applied, a discharge starts from the discharging points (i.e. the tips to charge the image carrier 1) to charge the image carrier 1. Note that the discharge electrode 20 may be composed of an array of needles or pins instead of the one having a serrated edge. Alternatively, the discharge electrode 20 may be composed of wire, such as tungsten wire. In such a case, the discharging point (s) correspond to the portion (s) of the discharge electrode 20 closest to the image carrier 1.

The control electrode 21 may be formed, for example, of mesh. One specific example of the control electrode 21 is a grid mesh made of stainless steel added with nickel. The control electrode 21 is disposed at an opening of the shielding case 22. That means, the control electrode 21 is located between the discharge electrode 20 and the image carrier 1. Upon an application of an intermediate voltage Vg (−500V in this example) between the potential of the discharge electrode 20 and the image carrier 1, the control electrode 21 serves to stabilize the discharge of the discharge electrode.

The shielding case 22 may be a housing made of stainless steel and having an elongated shape. The shielding case 22 has the opening across its length on the surface facing toward the image carrier 1, and the discharge electrode 20 is housed within the shielding case 22. At a location coinciding with the opening of the shielding case 22, the control electrode 21 is disposed. The shielding case 22 serves to contain the electric fields generated as a result of voltage application to the discharge electrode 20 and the control electrode 21.

Note that the shape of the shielding case 22 is partly different from that of a conventional shielding case. That is, the shielding case 22 has a pair of side plates S1 and S2 opposing to each other in the rotating direction R of the image carrier 1. Unlike a conventional shielding case having such side plates each having the shape of a flat plate, at least either of the side plates S1 and S2 of the shielding case 22 (only the one side located on a downstream side in Embodiment 1) has a bulged portion at a location in the vicinity of the opening. In other words, the portion of the side plate close to the image carrier 1 flares outwardly (i.e., in a direction away from the discharge electrode 20). The outline of the shielding case 22 will be described later in more detail.

The air duct 23 is used to exhaust ozone (O₃), nitrogen oxide (NOx), and the like that are produced in an unneglectable amount during the discharge.

The fun 24 is a blower that is driven by an electric motor to produce a flow current in the air duct 23 and the charging device 2.

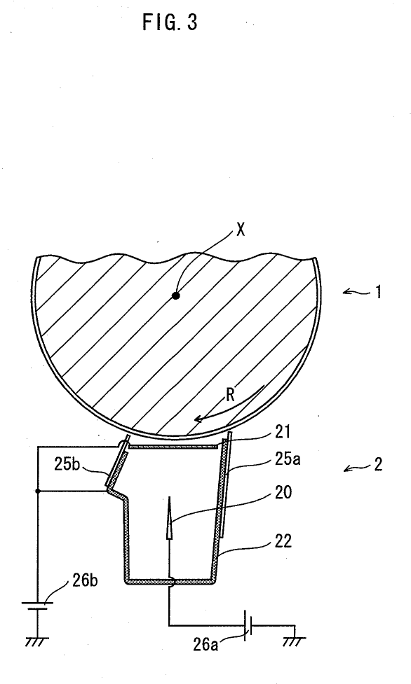

FIG. 3 shows the major part of the charging device 2 shown in FIG. 2 in a cross section taken along a plane perpendicular to the rotation axis x of the image carrier 1. FIG. 3 also shows a schematic representation of the electrical connection.

Note that although the image carrier 1 described herein has a roller-type photoreceptor and thus has the rotation axis x, the present invention is not limited to such a roller-type photoreceptor and also applicable to any structural component of any shape as long as it needs to by charged. That is to say, the image carrier 1 may be formed of a belt-type photoreceptor. In such a case, the rotation of the image carrier 1 refers to the driving of the belt to run around. Yet, since the belt-type image carrier 1 does not have a rotation axis, the description given above does not fit. In view of this, the sectional view shown in FIG. 3 may be defined as a plane taken along “a plane substantially perpendicular to the extending direction of the discharge electrode 20”.

As shown in FIG. 3, the charging device 2 consistent with the present embodiment has anti-ionic-wind sheets 25a and 25b. The anti-ionic-wind sheet 25a is attached to the side plate S2 located at the upstream side of the rotation direction, whereas the anti-ionic-wind sheet 25b is attached to the side plate S1 located at the downstream side of the rotation direction. The discharge electrode 20 is connected to a high voltage source 26a that includes a high-voltage transformer. The control electrode 21 and the shielding case 22 are electrically connected and at the same potential. The control electrode 21 and the shielding case 22 are also connected to a high voltage source 26b of which output voltage is lower than the output voltage of the high voltage source 26a connected to the discharge electrode 20.

In response to output voltages of the predetermined levels from the respective high voltage source 26a and 26b, a discharge starts from the discharge electrode 20 toward the control electrode 21 and the image carrier 1. As a result of the discharge, the surface of the image carrier 1 becomes charged. Thus, by rotating the image carrier 1 while the discharge is maintained, the surface of the image carrier 1 becomes uniformly charged.

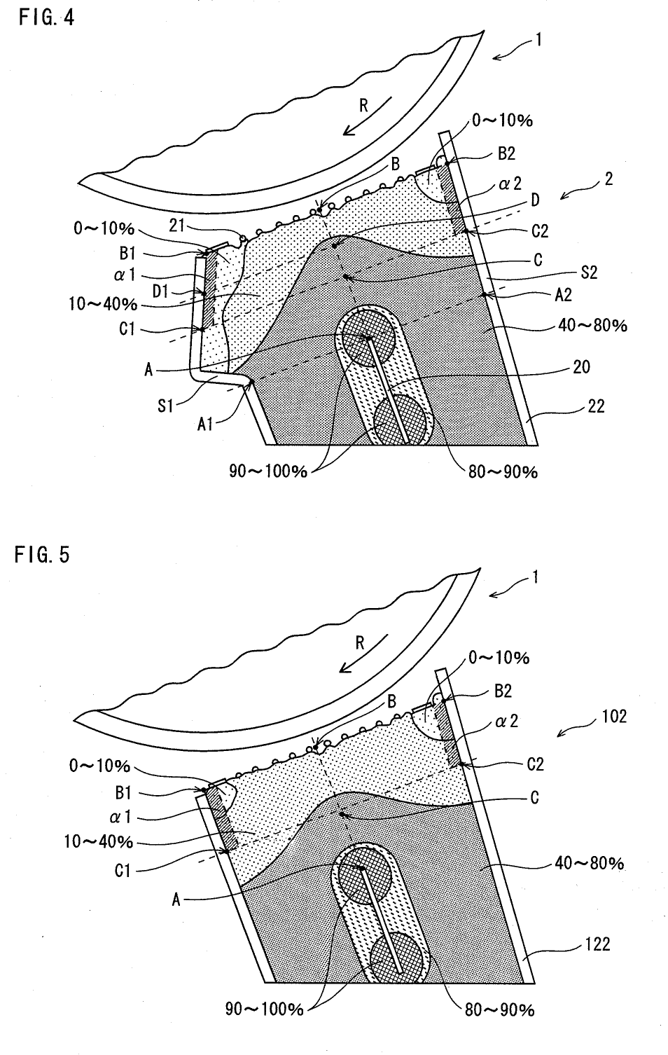

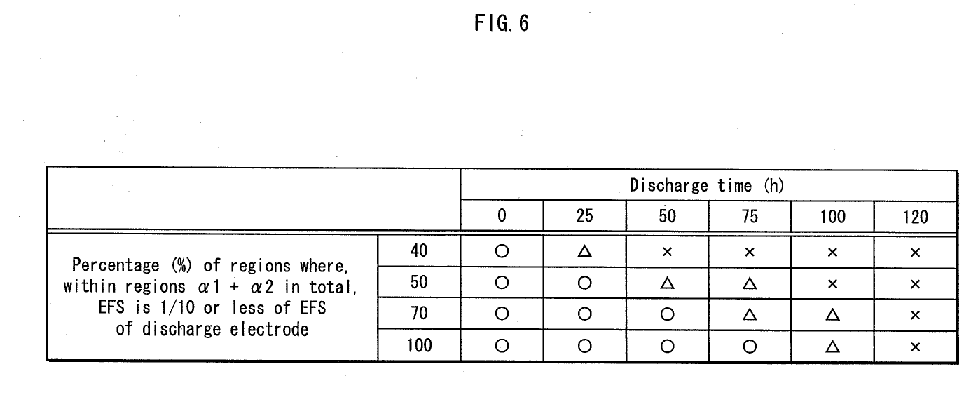

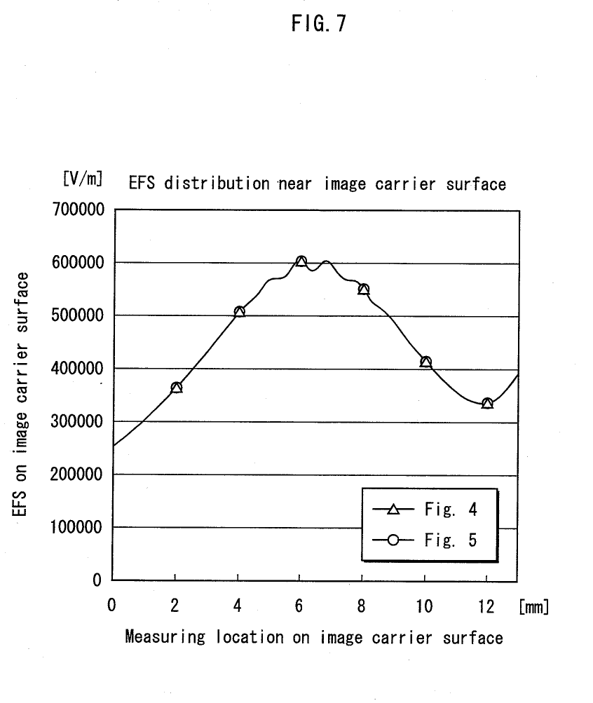

FIG. 4 is a view showing the cross section of the charging device 2 shown in FIG. 3, with the distribution of electric field strengths calculated by running simulations.

In the simulations, the output voltage of the high voltage source 26a was −5000V, whereas the output voltage of the high voltage source 26b was −500V. In FIG. 4, the electric field strength in the vicinity of the discharging point A on the discharge electrode 20 during the discharge is taken as “1” (i.e., as “reference electric field strength”). The electric field strength distribution within the shielding case 22 is shown by classifying into the following five regions: the first region where the electric field strength falls within a range from <90% to 100% of the reference electric field strength; the second region where the electric field strength falls within a range from <80% to 90%; the third region where the electric field strength falls within a range from <40% to 80%; the fourth region where the electric field strength falls within a range from <10% to 40%; and the fifth region where the electric field strength falls within a range from 0% to 10%.

In the cross section shown in FIG. 4, the side plate S1 having the bulged portion shows such an outline that outwardly tapered (i.e., the amount of bulge gradually increases) up to a position that is a predetermined distance away from the opening of the shielding case 22 and then inwardly tapered (i.e., the amount of budge gradually decreases) as the distance from the position increases. That is, the outline of the bulged portion of the side plate S1 according to the present embodiment has a cranked shape.

With reference to the cross section shown in FIG. 4, the following are defined for purposes of description. First, let “B” denote a point that is closest to the discharging point A of the discharge electrode 20 and on a line coinciding with the control electrode 21. In addition, let “AB” denotes a straight line segment connecting the discharging point A and the point B. Let “B1” denote a point of intersection between (i) a straight line that is substantially perpendicular to the line segment AB and passing through the point B and (ii) the inner surface of the side plate S1, which is located at the downstream side of the rotation direction. Let “C” denote the mid-point of the line segment AB, and “D” denote an arbitrary point located between the point B and the mid-point C. Let “D1” a point of intersection between (i) a straight line that is substantially perpendicular to the line segment AB and passing through the point D and (ii) the inner surface of the side plate S1. Then, the shielding case 22 has such a shape and dimensions that satisfy the following condition. That is, an arbitrary straight line connecting every possible point D and the point D1 is longer than the straight line connecting the points B and B1. As long as this condition is satisfied, the side plate having a bulged portion having the outline of any shape other than a cranked shape serves to produce the advantageous effect of suppressing undesirable discharge to the shielding case 22. The advantageous effect will be described later in more detail.

With reference to the cross section shown in FIG. 4, the following are further defined for purposes of description. Let “A1” denotes a point of intersection between (i) a straight line that is substantially perpendicular to the line segment AB and passing through the discharging point A and (ii) the inner surface of the side plate S1. Then, the shielding case 22 further satisfies the following condition. That is, the straight line connecting the discharging point A and the point Al is shorter than the straight line connecting every possible point D and the point D1. As long as this condition is further satisfied, it is ensured that the shielding case on the whole is kept compact in size, while sufficiently suppressing undesirable discharge to the shielding case 22.

### <Verification>

Firstly, the following verifies whether or not occurrences of image deletion is effectively suppressed.

FIG. 5 shows a cross section of a charging device 102 of a comparative example, with the distribution of electric field strengths calculated by running simulations in the same manner to FIG. 4 relating to the charging device 2.

Note that the charging device 102 of the comparative example shown in FIG. 5 corresponds to a conventional charging device and basically identical in structure to the charging device 2 shown in FIG. 4, except for the shape of the shielding case. Thus, components shown in FIG. 4 that correspond to those shown in FIG. 5 are identified with the same reference numerals.

FIG. 6 shows a table of results of experiment made on the following four charging devices to check for occurrence of image deletion (or “image blurring”) in relation to different length of discharge time. Note that four charging devices includes the charging device 2 shown in FIG. 4 and the charging device 102 shown in FIG. 5.

With reference to FIGS. 4 and 5, the followings are defined for purposes of purposes of description. Let “B2” denote a point of intersection between (i) the straight line substantially perpendicular to the line segment AB and passing through the point B and (ii) the inner surface of the side plate S2, which is located at the upstream side of the rotation direction. Let “C1” and “C2” denote points of intersection between (i) the straight line substantially perpendicular to the line segment AB and passing through the mid-point C and (ii) the inner surface of each of the side plates S1 and S2. Let “a1” denote the region located inwardly along the part of the inner surface of the side plate S1 delimited between the points B1 and C1. Let “a2” denote the region located inwardly along the part of the inner surface of the side plate S2 delimited between the points B2 and C2.

As shown in the table in FIG. 6, the experiments were conducted on the four charging devices having the regions where the electric field strength is 10% or less of the reference electric field strength (i.e. the region classified as the “fifth region”) occupy about 40% of the total of the “a1+a2 regions”, about 50%, about 70%, and 100%. Note that the device having the fifth regions occupying about 70% corresponds to the charging device 2 shown in FIG. 4, whereas the device having the fifth regions occupying about 40% corresponds to the charging device 102 shown in FIG. 5.

In the experiment, first, each of the subject devices were operated to cause accelerative discharge and sequentially brought into the six different states in terms of the lengths of discharge time. In each state, the respective devices were operated to print out a test pattern image on 1,000 sheets of A4-size paper in succession. After being allowed to stand for 24 hours, the printed sheets were compared against limit samples to make judgments on the image quality. In FIG. 6, the mark “◯” indicates the judgment that the image quality is acceptable without any problem at all. The mark “Δ” indicates the judgment that the image quality is acceptable, although slight image deletion is noted. More specifically, the image deletion is of minor nature as compared with those of the limit samples and an acceptable level of legibleness is still ensured. The mark “×” indicates the judgment that the image quality is not acceptable since the image deletion is observed and the image quality is judged to be inferior to the limit samples.

FIG. 6 shows that image deletion occurred less and less with the increase in the percentage of the fifth region in the total of “a1+a2 regions”, even if the discharge time became longer.

Regarding the charging device having the fifth region occupying about 40% of the total of “a1+a2 regions” (i.e., the charging device 102 of the comparative example), the following is noted. While the discharge time was 0 hours (initial state), no problem was observed at all. However, when the discharge time reached about 25 hours, slight image deletion was observed. When the discharge time reached about 50 hours or more, the image quality of the printed output was no longer acceptable. This experimental result shows that the life of this charging device is shorter than the estimated life of typical compact printers. It is thus concluded that this device is not applicable to printers in general.

Regarding the charging device having the fifth region occupying about 50% of the total of “a1+a2 regions”, the following is noted. Up until the discharge time reached 25 hours, the device exhibited no problem at all. However, when the discharge time reached about 50 hours and about 75 hours, slight image deletion was observed. After the discharge time reached about 100 hours, the image quality of the printed output was no longer acceptable. This experimental result shows that this charging device is configured to withstand the discharge time of 25 hours or more, which is longer than the estimated life of typical compact printers. Thus, this charging device is applicable to compact printers.

Regarding the charging device having the fifth region occupying about 70% of the total of “a1+a2 regions” (i.e., the charging device 2 shown in FIG. 4), the following is noted. Up until the discharge time reached 50 hours, the charging device exhibited no problem at all. After the discharge time reached about 75 hours and about 100 hours, slight image deletion was observed. After the discharge time reached about 120 hours or more, the image quality of the printed output was no longer acceptable. This experimental result shows that the charging device is configured to withstand the discharge time of 50 hours or more, which is longer than the estimated life of general-purpose printers. Thus, this type of charging device is applicable to general-purpose printers.

Regarding the charging device having the fifth region occupying about 100% of the total of “a1+a2 regions”, the following is noted. Up until the discharge time reached 75 hours, this charging device exhibited no problem at all. After the discharge time reached about 100 hours, slight image deletion was observed. After the discharge time reached about 120 hours or more, the image quality of the printed output was no longer acceptable. This experimental result shows that the charging device is configured to withstand the discharge time of 75 hours or more, which is longer than the estimated life of typical large printers. Thus, this type of charging device is applicable to typical large printers.

As shown by the experimental results, the size and shape of the bulged portion of the shielding case 22 maybe adjusted so that the percentage of the fifth region occupying the total of “a1+a2 regions” fall in a desired one of the ranges suitable for image forming apparatuses of different specifications (such as large and small). With such an adjustment, the charging device suitable for a specific image forming apparatus is provided.

Next, the following now verifies the original performance of the charging device.

FIG. 7 is a graph showing the distribution of electric field strengths in the vicinity of the surface of the image carrier 1, regarding both the charging device 2 shown in FIG. 4 and the charging device 102 shown in FIG. 5. In FIG. 7, the horizontal axis of the graph indicates the measuring locations [mm] on the surface of the image carrier 1. Each measuring location is indicated by the distance from the ZERO location toward the upstream direction. The ZERO location is set at a location that corresponds, in the vertical direction, to a downstream-side edge of the control electrode 21. The vertical axis of the graph indicates the electric field strength [V/m] measured on the respective measuring locations on the surface of the image carrier 1. The electric field strength is a substitutional characteristic for the charged amount.

As apparent from FIG. 7, the charging device 2 shown in FIG. 4 and the charging device 102 shown in FIG. 5 both exhibited substantially identical distributions of the electric field strengths in the vicinity of the surfaces of the respective image carriers 1. This means that the two devices are without any notable difference regarding the balance of the discharge current and identical in terms of the performance.

Note that the image carrier 1 according to the present embodiment is an OPC photoreceptor. However, an AL photoreceptor may be employed instead of the OPC photoreceptor in the structures shown in FIGS. 4 and 5. In the case where an AL photoreceptor is employed in each structure, the percentage of the amount of electric current flowing through the AL photoreceptor, the control electrode, the shielding case is as follows. Regarding the structure shown in FIG. 4, the amount electric current flowing through the AL photoreceptor is 51%, the control electrode is 34.5%, and the shielding case is 14.5% of the entire electric current. With the structure shown in FIG. 5, the amount electric current flowing through the AL photoreceptor is 51.5%, the control electrode is 36%, and the shielding case is 12.5% of the entire electric current. The comparison between them show that the charging device 2 shown in FIG. 4 and the charging device 102 shown in FIG. 5 exhibit no notable difference regarding the balance of the discharge current, even if the image carrier 1 is an AL photoreceptor instead of an OPC photoreceptor. Thus, the two devices are identical in terms of the performance.

### <Recapitulation>

As has been described above, in the charging device for use in an electrographic image forming apparatus according to the present embodiment, at least either of the pair of side plates of the shielding case has an outline that outwardly bulges at a portion closer to the opening. This structure produces an excellent advantageous effect of suppressing corrosion of the shielding case and suppressing occurrences of image deletion. In addition, these effects are achieved without complicating the device structure, inhibiting the size reduction, and increasing the cost.

### Embodiment 2

### <Structure>

According to Embodiment 1 described above, one of the side plates has a cranked shape. Embodiment 2 differs from Embodiment 1 in that both the side plates have a cranked shape.

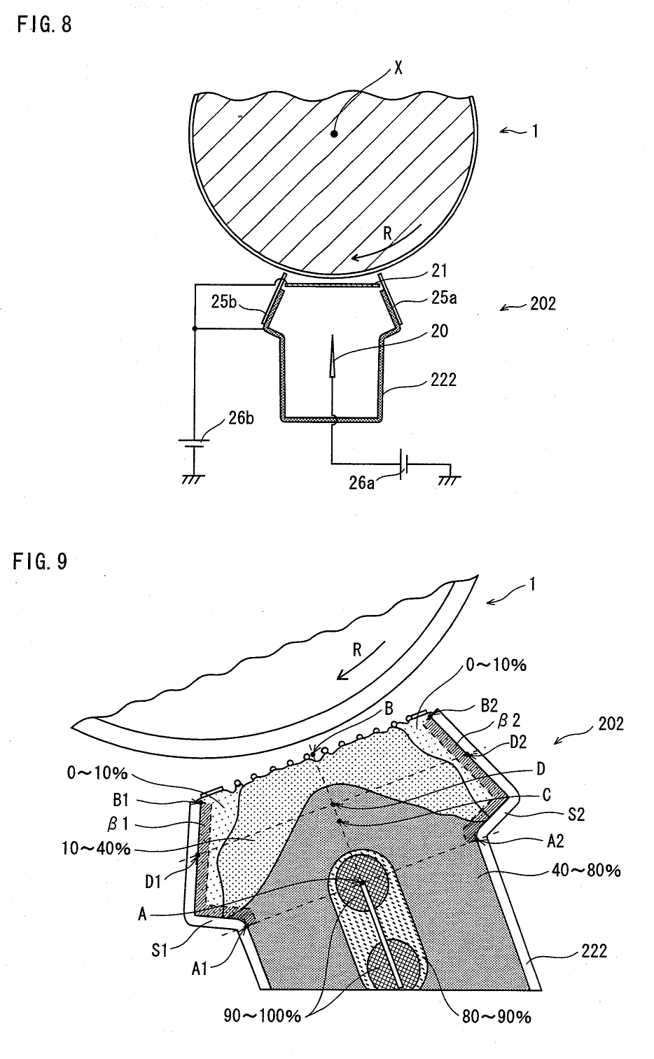

FIG. 8 is a cross sectional view showing the major part of a charging device 202 consistent with Embodiment 2. The cross section is taken along a plane perpendicular to the rotation axis x of an image carrier 1. FIG. 8 also shows a schematic representation of the electrical connection. The charging device 202 of Embodiment 2 is basically identical to the charging device 2 of Embodiment 1, except for the shape of the shielding case. Thus, the identical components are identified with the same reference numerals.

As shown in FIG. 8, the charging device 202 consistent with the present embodiment has a shielding case 222 and anti-ionic-wind sheets 25a and 25b each attached to the outer surface of either side plate of the shielding case 222. A discharge electrode 20 is connected to the high voltage source 26a that includes a high-voltage transformer. A control electrode 21 and the shielding case 222 are electrically connected and at the same potential. The control electrode 21 and the shielding case 222 are also connected to a high voltage source 26b of which output voltage is lower than the output voltage of the of a high voltage source 26a connected to the discharge electrode 20. Note that the anti-ionic-wind sheets 25a according to Embodiments 1 and 2 are different in shape. Yet, there is no difference in their functionality, so that both the sheets are identified with the same reference numeral.

FIG. 9 is a view showing the cross section of the charging device 202 shown in FIG. 8, with the distribution of electric field strengths calculated by running simulations.

Similarly to Embodiment 1, in FIG. 9, the output voltage the high voltage source 26a is −5000V, whereas the output voltage of the high voltage source 26b is −500V. In addition, the electric field strength in the vicinity of the discharging point A on the discharge electrode 20 during the discharge is taken as “1” (i.e., as “reference electric field strength”). The electric field strength distribution within the shielding case 222 is shown by classifying into the following five regions: the first region where the electric field strength falls within a range from <90% to 100% of the reference electric field strength; the second region where the electric field strength falls within a range from <80% to 90%; the third region where the electric field strength falls within a range from <40% to 80%; the fourth region where the electric field strength falls within a range from <10% to 40%; and the fifth region where the electric field strength falls within a range from 0% to 10%.

In the cross section shown in FIG. 9, each of the side plates S1 and S2 has a bulged portion. Each bulged portion shows such an outline that outwardly tapered (i.e., the amount of bulge gradually increases) up to a position that is a predetermined distance away from the opening of the shielding case 222 and then inwardly tapered (i.e., the amount of budge gradually decreases) as the distance from the position increases. That is, the outline of each bulged portion according to the present embodiment has a cranked shape.

With reference to the cross section shown in FIG. 9, the following are defined for purposes of description. First, let “B” denotes a point that is closest to the discharging point A of the discharge electrode 20 and on a line coinciding with the control electrode 21. Let “AB” denote a straight line segment connecting the discharging point A and the point B. Let “B1” denote a point of intersection between (i) a straight line that is substantially perpendicular to the line segment AB and passing through the point B and (ii) the inner surface of the side plate S1, which is located at the downstream side of the rotation direction. Let “B2” denote a point of intersection between (i) the straight line that is substantially perpendicular to the line segment AB and passing through the point B and (ii) the inner surface of the side plate S2, which is located at the upstream side of the rotation direction. Let “C” denote the mid-point of the line segment AB, and “D” denote an arbitrary point located between the point B and the mid-point C. Let “D1” denote a point which of intersection between (i) a straight line that is substantially perpendicular to the line segment AB and passing through the point D and (ii) the inner surface of the side plate S1. Let “D2” denote a point intersection between (i) the straight line that is substantially perpendicular to the line segment AB and passing through the point D and (ii) the inner surface of the side plate S2. Then, the shielding case 222 has such a shape and dimensions that satisfy the following condition. That is, an arbitrary straight line connecting every possible point D and the point D1 is longer than the straight line connecting the points B and B1. In addition, an arbitrary straight line connecting every possible point D and the point D2 is longer than the straight line connecting the point B and the point B2. As long as this condition is satisfied, the pair of side plates each having a bulged portion having the outline of any shape other than a cranked shape serves to produce the advantageous effect of suppressing undesirable discharge to the shielding case 222. The advantageous effect will be described later in more detail.

With reference to the cross section shown in FIG. 9, the following are further defined for purposes of description. Let “A1” denote a point of intersection between (i) a straight line that is substantially perpendicular to the line segment AB and passing through the discharging point A and (ii) the inner surface of the side plate S1. Let “A2” denote a point of intersection between (i) the straight line that is substantially perpendicular to the line segment AB and passing through the discharging point A and (ii) the inner surface of the side plate S2. Then, the shielding case 222 further satisfies the following condition. That is, the straight line connecting discharging point A and the point Al is shorter than the straight line connecting every possible point D and the point D1. Further, the straight line connecting discharging point A and the point A2 is shorter than the straight line connecting every possible point D and the point D2. As long as this condition is further satisfied, it is ensured that the shielding case 222 on the whole is kept compact in size, while sufficiently suppressing undesirable discharge to the shielding case 222.

### <Verification>

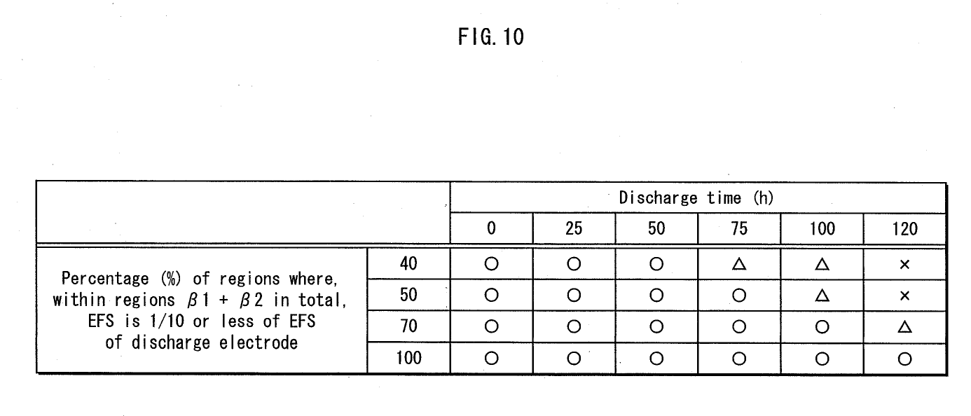

FIG. 10 shows a table of results of experiment made on the following four charging devices, including the charging device 202 shown in FIG. 9 to check for occurrence of image deletion (or “image blurring”) in relation to different length of discharge time.

With reference to FIG. 9, the followings are defined for purposes of purposes of description. Let “A1” denote a point of intersection between (i) the straight line substantially perpendicular to the line segment AB and passing through the discharging point A and (ii) the inner surface of the side plate S1. Let “A2” denote a point of intersection between (i) the straight line substantially perpendicular to the line segment AB and passing through the discharging point A and (ii) the inner surface of the side plate S2. Let “B1” denote a point of intersection between (i) the straight line substantially perpendicular to the line segment AB and passing through the point B and (ii) the inner surface of the side plate S1. Let “B2” denote a point of intersection between (i) the straight line substantially perpendicular to the line segment AB and passing through the point B and (ii) the inner surface of the side plate S2. Let “β1” denote the region located inwardly along the part of the inner surface of the side plate S1 delimited between the points B1 and Al. Let “β2” denote the region located inwardly along the part of the inner surface of the side plate S2 delimited between the points B2 and A2.

As shown in the table in FIG. 10, the experiments were conducted on the four charging devices having the regions where the electric field strength is 10% or less of the reference electric field strength (i.e. the region classified as the “fifth region”) occupy about 40% of the total of the “β1+β2 regions”, about 50%, about 70% (the charging device 202 shown in FIG. 9), and 100%.

Similarly to Embodiment 1, in the experiment, each of the subject devices were operated to cause accelerative discharge and sequentially brought into the six different states in terms of the lengths of discharge time. In each state, the respective devices were operated to print out a test pattern image on 1,000 sheets of A4-size paper in succession. After being allowed to stand for 24 hours, the printed sheets were compared against limit samples to make judgments on the image quality. In FIG. 10, the mark “◯” indicates the judgment that the image quality is acceptable without any problem at all. The mark “Δ” indicates the judgment that the image quality is acceptable, although slight image deletion is noted. More specifically, the image deletion is of minor nature as compared with those of the limit samples and an acceptable level of legibleness is still ensured. The mark “×” indicates the judgment that the image quality is not acceptable since the image deletion is observed and the image quality is judged to be inferior to the limit samples.

FIG. 10 shows that image deletion occurred less and less with the decrease in the percentage of the fifth region in the total of “β1+β2 regions”, even if the discharge time became longer.

Regarding the charging device having the fifth region occupying about 40% of the total of “β1+β2 regions”, the following is noted. Up until the discharge time reached 50 hours, the device exhibited no problem at all. However, when the discharge time reached about 75 hours and about 100 hours, slight image deletion was observed. After the discharge time reached about 120 hours, the image quality of the printed output was no longer acceptable. This experimental result shows that this charging device is configured to withstand the discharge time of 50 hours or more, which is longer than the estimated life of general-purpose printers. Thus, this type of charging device is applicable to general-purpose printers.

Regarding the charging device having the fifth region occupying about 50% of the total of “β1+β2 regions”, the following is noted. Up until the discharge time reached 75 hours, the charging device exhibited no problem at all. After the discharge time reached about 100 hours, slight image deletion was observed. After the discharge time reached about 120 hours or more, the image quality of the printed output was no longer acceptable. This experimental result shows that the charging device is configured to withstand the discharge time of 75 hours or more, which is longer than the estimated life of most of general-purpose printers. Thus, this type of charging device is applicable to almost all types of printers.

Regarding the charging device having the fifth region occupying about 70% of the total of “β1+β2 regions”, the following is noted. Up until the discharge time reached 100 hours, the charging device exhibited no problem at all. After the discharge time reached about 120 hours, slight image deletion was observed.

Regarding the charging device having the fifth region occupying about 100% of the total of “β1+β2 regions”, the following is noted. In the state where the discharge time reached 120 hours, the charging device exhibited no problem at all.

### <Recapitulation>

As has been described above, the charging device for use in an electrographic image forming apparatus according to the present embodiment, each of the pair of side plates of the shielding case has an outline that outwardly bulges at a portion closer to the opening. Although being a little more complex and expensive as compared with the structure of Embodiment 1, the structure of Embodiment 2 produces an excellent advantageous effect of suppressing corrosion of the shielding case and suppressing occurrences of image deletion. In addition, these effects are achieved without complicating the device structure, inhibiting the size reduction, and increasing the cost.

### [Modification 1]

According to Embodiment 1, one of the side plates of the shielding case has a bulged portion with a cranked outline, at a portion in the vicinity of the opening. According to Modification 1, the budged portion has a circularly curved outline instead of a cranked outline.

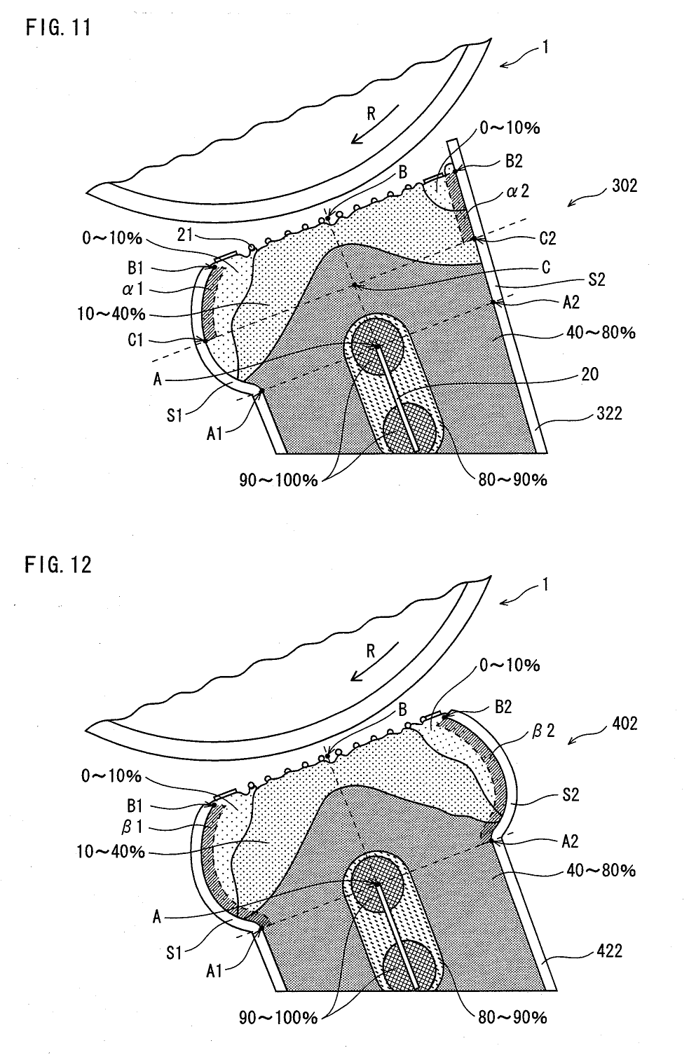

Similarly to FIG. 4 relating to Embodiment 1, FIG. 11 shows the section of a charging device 302 according to Modification 1, with the distribution of electric field strengths calculated by running simulations.

As apparent from FIG. 11, the charging device 302 consistent with Modification 1 is basically identical to the charging device 2 according to Embodiment 1, except for that the structure of a shielding case 322 is partly different from that of the shielding case 22. That is, the charging device 302 exhibits a similar electric field strength distribution and achieves similar advantageous effects as those of Embodiment 1.

### [Modification 2]

According to Embodiment 2, each of the side plates of the shielding case has a budged portion with a cranked outline, at a portion in the vicinity of the opening. According to Modification 2, each budged portion has a circularly curved outline instead of a cranked outline.

Similarly to FIG. 9 relating to Embodiment 2, FIG. 12 shows the section of a charging device 402 according to Modification 2, with the distribution of electric field strengths calculated by running simulations.

As apparent from FIG. 12, the charging device 402 consistent with Modification 2 is basically identical to the charging device 202 according to Embodiment 2, except for that the structure of a shielding case 422 is partly different from that of the shielding case 222. That is, the charging device 402 exhibits a similar electric field strength distribution and achieves similar advantageous effects as those of Embodiment 2.

Note in addition, the bulged portion according to Modifications 1 and 2 has the circularly curved outline. Alternatively, however, the outline of the budged portion may include either a curve defining a portion of a circular or elliptical shape or a curve defining a combination of portions of circular and elliptical shapes. In either case, the bulged portion has a continuously-curved outline, which allows manufacturing with ease and invariant properties.

Note in addition, although Embodiments 1 and 2 and Modifications 1 and 2 employ the image carrier 1 having a roller-type photoreceptor, the present invention is applicable to any structural component of any shape as long as it needs to by charged. For example, the image carrier 1 may be an intermediate transfer medium. In addition, the image carrier 1 may be a belt-type image carrier or a drum-type image carrier.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A charging device for charging a surface of a rotating image carrier, the charging device comprising:
a shielding case having an opening at a location facing toward the image carrier;
a corona electrode hung within the shielding case to longitudinally extend in a direction perpendicular to a direction of the rotation; and
a control electrode disposed at a location of the opening of the shielding case, wherein
a pair of side plates of the shielding case are opposed to each other in the direction of the rotation, and at least one of the side plates has a portion that outwardly bulges at a location in a vicinity of the opening.

2. The charging device according to claim 1, wherein
in a cross section substantially perpendicular to the extending direction of the corona electrode, an outline of the bulged portion includes a circular or elliptical curve or a combination of circular and elliptical curves.

3. The charging device according to claim 1, wherein
in a cross section substantially perpendicular to the extending direction of the corona electrode, an outline of the bulged portion includes a cranked shape.

4. The charging device according to claim 1, wherein
only one of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
B1 and B2 each denote a point of intersection between (i) an inner surface of each of the side plates S1 and S2, respectively and (ii) a line segment substantially perpendicular to the line segment AB and passing through the point B,
C denotes a midpoint of the line segment AB,
C1 and C2 each denote a point of intersection between (i) the inner surface of each of the side plates S1 and S2, respectively and (ii) a line segment substantially perpendicular to the line segment AB and passing through the point C,
a1 denotes a region located inwardly along a part of the inner surface of the side plate S1 delimited between the points B1 and C1,
a2 denotes a region located inwardly along a part of the inner surface of the side plate S2 delimited between the points B2 and C2, and
the bulged portion satisfies the following relation,
in the entire regions a1 and a2, an electric field strength is 1/10 or less of an electric field strength in a vicinity of the discharging point A.

5. The charging device according to claim 1, wherein
only one of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
B1 and B2 each denote a point of intersection between (i) an inner surface of each of the side plates S1 and S2, respectively and (ii) a line segment substantially perpendicular to the line segment AB and passing through the point B,
C denotes a midpoint of the line segment AB,
C1 and C2 each denote a point of intersection between (i) the inner surface of each of the side plates S1 and S2, respectively and (ii) a line segment substantially perpendicular to the line segment AB and passing through the point C,
a1 denotes a region located inwardly along a part of the inner surface of the side plate S1 delimited between the points B1 and C1,
a2 denotes a region located inwardly along a part of the inner surface of the side plate S2 delimited between the points B2 and C2, and
the bulged portion satisfies the following relation,
in 70% or more of the entire regions a1 and a2, an electric field is 1/10 or less of an electric field strength in a vicinity of the discharging point A.

6. The charging device according to claim 1, wherein
only one of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
B1 and B2 each denote a point of intersection between (i) an inner surface of each of the side plates S1 and S2, respectively and (ii) a line segment substantially perpendicular to the line segment AB and passing through the point B,
C denotes a midpoint of the line segment AB,
C1 and C2 each denote a point of intersection between (i) the inner surface of each of the side plates S1 and S2, respectively and (ii) a line segment substantially perpendicular to the line segment AB and passing through the point C,
a1 denotes a region located inwardly along a part of the inner surface of the side plate S1 delimited between the points B1 and C1,
a2 denotes a region located inwardly along a part of the inner surface of the side plate S2 delimited between the points B2 and C2, and
the bulged portion satisfies the following relation,
in 50% or more of the entire regions a1 and a2, an electric field is 1/10 or less of an electric field strength in a vicinity of the discharging point A.

7. The charging device according to claim 1, wherein
only one of the side plates that is located closer toward downstream in the direction of the rotation has a bulged portion.

8. The charging device according to claim 1, wherein
each of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
A1 and A2 each denote a point of intersection between (i) an inner surface of each of the side plates S1 and S2, respectively and (ii) a line segment substantially perpendicular to the line segment AB and passing through the discharge point A,
B1 and B2 each denote a point of intersection between (i) the inner surface of each of the side plates. S1 and S2, respectively and (ii) a line segment substantially perpendicular to the line segment AB and passing through the point B,
β1 denotes a region located inwardly along a part of the inner surface of the side plate S1 delimited between the points B1 and A1,
β2 denotes a region located inwardly along a part of the inner surface of the side plate S2 delimited between the points B2 and A2, and
the bulged portion satisfies the following relation,
in 50% or more of the entire regions β1 and β2, an electric field is 1/10 or less of an electric field strength in a vicinity of the discharging point A.

9. The charging device according to claim 1, wherein
each of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
A1 and A2 each denote a point of intersection between (i) an inner surface of each of the side plates S1 and S2, respectively and (ii) a line segment substantially perpendicular to the line segment AB and passing through the discharge point A,
B1 and B2 each denote a point of intersection between (i) the inner surface of each of the side plates S1 and S2, respectively and (ii) a line segment substantially perpendicular to the line segment AB and passing through the point B,
β1 denotes a region located inwardly along a part of the inner surface of the side plate S1 delimited between the points B1 and A1,
β2 denotes a region located inwardly along a part of the inner surface of the side plate S2 delimited between the points B2 and A2, and
the bulged portion satisfies the following relation,
in 40% or more of the entire regions β1 and β2, an electric field is 1/10 or less of an electric field strength in a vicinity of the discharging point A.

10. An image forming apparatus comprising:
an image carrier that is a rotating body; and
a charger operable to charge a surface of the image carrier, wherein
the charging device includes:
a shielding case having an opening at a location facing toward the image carrier;
a corona electrode hung within the shielding case to longitudinally extend in a direction perpendicular to a direction of the rotation; and
a control electrode disposed at a location of the opening of the shielding case, and
a pair of side plates of the shielding case are opposed to each other in the direction of the rotation, and at least one of the side plates has a portion that outwardly bulges at a location in a vicinity of the opening.

11. The image forming apparatus according to claim 10, wherein
in a cross section substantially perpendicular to the extending direction of the corona electrode, an outline of the bulged portion includes a circular or elliptical curve or a combination of circular and elliptical curves.

12. The image forming apparatus according to claim 10, wherein.
in a cross section substantially perpendicular to the extending direction of the corona electrode, an outline of the bulged portion includes a cranked shape.

13. The image forming apparatus according to claim 10, wherein
only one of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
B1 and B2 each denote a point of intersection between (i) an inner surface of each of the side plates S1 and S2, respectively and (ii) a line segment substantially perpendicular to the line segment AB and passing through the point B,
C denotes a midpoint of the line segment AB,
C1 and C2 each denote a point of intersection between (i) the inner surface of each of the side plates S1 and S2, respectively and (ii) a line segment substantially perpendicular to the line segment AB and passing through the point C,
a1 denotes a region located inwardly along a part of the inner surface of the side plate S1 delimited between the points B1 and C1,
a2 denotes a region located inwardly along a part of the inner surface of the side plate S2 delimited between the points B2 and C2, and
the bulged portion satisfies the following relation,
in the entire regions a1 and a2, an electric field strength is 1/10 or less of an electric field strength in a vicinity of the discharging point A.

14. The image forming apparatus according to claim 10, wherein
only one of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
B1 and B2 each denote a point of intersection between (i) an inner surface of each of the side plates S1 and S2, respectively and (ii) a line segment substantially perpendicular to the line segment AB and passing through the point B,
C denotes a midpoint of the line segment AB,
C1 and C2 each denote a point of intersection between (i) the inner surface of each of the side plates S1 and S2, respectively and (ii) a line segment substantially perpendicular to the line segment AB and passing through the point C,
a1 denotes a region located inwardly along a part of the inner surface of the side plate S1 delimited between the points B1 and C1,
a2 denotes a region located inwardly along a part of the inner surface of the side plate S2 delimited between the points B2 and C2, and
the bulged portion satisfies the following relation,
in 70% or more of the entire regions a1 and a2, an electric field is 1/10 or less of an electric field strength in a vicinity of the discharging point A.

15. The image forming apparatus according to claim 10, wherein
only one of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
B1 and B2 each denote a point of intersection between (i) an inner surface of each of the side plates S1 and S2, respectively and (ii) a line segment substantially perpendicular to the line segment AB and passing through the point B,
C denotes a midpoint of the line segment AB,
C1 and C2 each denote a point of intersection between (i) the inner surface of each of the side plates S1 and S2, respectively and (ii) a line segment substantially perpendicular to the line segment AB and passing through the point C,
a1 denotes a region located inwardly along a part of the inner surface of the side plate S1 delimited between the points B1 and C1,
a2 denotes a region located inwardly along a part of the inner surface of the side plate S2 delimited between the points B2 and C2, and
the bulged portion satisfies the following relation,
in 50% or more of the entire regions a1 and a2, an electric field is 1/10 or less of an electric field strength in a vicinity of the discharging point A.

16. The image forming apparatus according to claim 10, wherein
only one of the side plates that is located closer toward downstream in the direction of the rotation has a bulged portion.

17. The image forming apparatus according to claim 10, wherein.
each of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
A1 and A2 each denote a point of intersection between (i) an inner surface of each of the side plates S1 and S2, respectively and (ii) a line segment substantially perpendicular to the line segment AB and passing through the discharge point A,
B1 and B2 each denote a point of intersection between (i) the inner surface of each of the side plates S1 and S2, respectively and (ii) a line segment substantially perpendicular to the line segment AB and passing through the point B,
β1 denotes a region located inwardly along a part of the inner surface of the side plate S1 delimited between the points B1 and A1,
β2 denotes a region located inwardly along a part of the inner surface of the side plate S2 delimited between the points B2 and A2, and
the bulged portion satisfies the following relation,
in 50% or more of the entire regions β1 and β2, an electric field is 1/10 or less of an electric field strength in a vicinity of the discharging point A.

18. The image forming apparatus according to claim 10, wherein
each of the side plates has a bulged portion,
in a cross section substantially perpendicular to the extending direction of the corona electrode,
A denotes a discharging point on the corona electrode,
B denotes a point closest to the discharge point A and on a line segment coinciding with the control electrode,
AB denotes a straight line segment connecting the discharge point A and the point B,
S1 and S2 each denote a different one of the side plates,
A1 and A2 each denote a point of intersection between (i) an inner surface of each of the side plates S1 and S2, respectively and (ii) a line segment substantially perpendicular to the line segment AB and passing through the discharge point A,
B1 and B2 each denote a point of intersection between (i) the inner surface of each of the side plates S1 and S2, respectively and (ii) a line segment substantially perpendicular to the line segment AB and passing through the point B,
β1 denotes a region located inwardly along a part of the inner surface of the side plate S1 delimited between the points B1 and A1,
β2 denotes a region located inwardly along a part of the inner surface of the side plate S2 delimited between the points B2 and A2, and
the bulged portion satisfies the following relation,
in 40% or more of the entire regions β1 and β2, an electric field is 1/10 or less of an electric field strength in a vicinity of the discharging point A.
